(19) United States
(12) Patent Application Publication
(10) Pub. No.: US 2011/0022422 A1
(43) Pub. Date: Jan. 27, 2011

(54) VEHICLE KEY SYSTEM AND METHOD

(76) Inventor: Norman G. Taylor, Dundee (GB)

Correspondence Address: PAUL W. MARTIN, NCR CORPORATION, LAW DEPT., 3097 SATELLITE BLVD., 2nd FLOOR, DULUTH, GA, 30096, US

(21) Appl. No.: 12/508,159

(22) Filed: Jul. 23, 2009

(51) Int. Cl. G06Q 10/00; E05B 65/12; E05B 49/00

(52) U.S. Cl. 705/5; 70/237; 70/278.2

(57) ABSTRACT

A vehicle key system and method which reduces problems with key management, distribution, and collection. The system includes a computer for completing a vehicle rental transaction involving one of a plurality of different vehicles, for determining an encrypted code associated with a vehicle security system of the one vehicle, and for storing the encrypted code in a reusable programmable key to limit use of the key to operating the one vehicle during a rental period defined by the vehicle rental transaction.

### BACKGROUND

At present, vehicle rental companies and their customers are challenged with key management, distribution, and collection. Each vehicle has its own unique key, which may include a conventional metal key, a metal key with a built-in security chip, or a wireless key.

Therefore, it would be desirable to provide an improved vehicle key system and method which simplifies key management, distribution, and collection. It would also be desirable to provide an improved vehicle key system and method which facilitates key distribution via multiple types of service channels, including, for example, assisted service, self-service, and mobile channels.

### SUMMARY

A vehicle key system and method is provided.

The system includes a computer for completing a vehicle rental transaction involving one of a plurality of different vehicles, for determining an encrypted code associated with a vehicle security system of the one vehicle, and for storing the encrypted code in a reusable programmable key to limit use of the key to operating the one vehicle during a rental period defined by the vehicle rental transaction.

### BRIEF DESCRIPTION OF THE DRAWINGS

FIG. 1 is a block diagram including an example vehicle key system.

FIG. 2 is a flow diagram illustrating a first example key distribution method.

FIG. 3 is a flow diagram illustrating a second example key distribution method.

### DETAILED DESCRIPTION

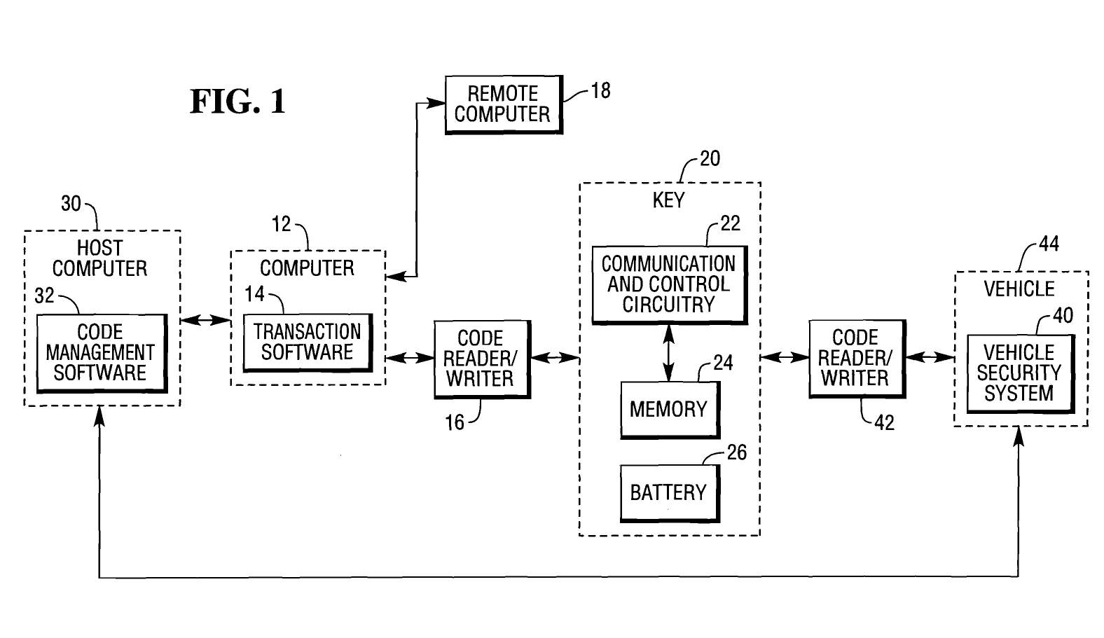

With reference to FIG. 1, example system 10 primarily includes computer 12.

Computer 12 executes transaction software 14 for completing a vehicle rental transaction involving an automobile or other motor vehicle 44. Transaction software 14 additionally programs vehicle key 20 for use with vehicle security system 40 so that a rental customer may operate vehicle 44. Transaction software 14 may additionally offer upgrades to more expensive vehicles that are available. Since keys 20 are programmable, there is no need to organize or search for keys. Transaction software 14 obtains an encrypted code associated with vehicle security system 40 from host computer 30 and stores the encrypted code within key 20.

Computer 12 includes a processor, memory, display, input device, and peripherals for completing vehicle rental transactions. The display and input device may be combined as a touch screen. An example peripheral includes a card reader for reading credit and other payment cards and code reader/writer 16 for reading and programming key 20.

Code reader/writer 16 may include a wired or wireless device. An example wireless device includes a near field communication (NFC) reader/writer. Code reader/writer 16 may be connected to computer 12 through a wired connection, such as a universal serial bus (USB) connection. Code reader/writer 16 may alternatively be integrated within computer 12.

Computer 12 may include many different types of computing devices. For example, computer 12 may include an assisted-service transaction terminal, typically located in a vehicle rental office. Alternatively, computer 12 may include a self-service transaction terminal or kiosk, which may also be located in a vehicle rental office. As yet another alternative, computer 12 may include a portable computing device, which gives vehicle rental employees the freedom to complete assisted-service vehicle rental transactions anywhere within vehicle rental locations.

As yet another alternative, computer 12 may include one or more computers at the same or different locations. For example, computer 12 may include a web server capable of completing an on-line transaction through an Internet or other network connection with a remote computer 18, and an in-store computer for programming key 20.

As another example, computer 12 may include a self-service computer, such as a kiosk, in an airport for completing a transaction, and a portable computer at a vehicle location for programming key 20.

Key 20 may be a card, key fob, token, or other tangible portable device. Key 20 communicates with vehicle security system 40 to lock and unlock vehicle doors, to start an engine or motor of vehicle 44, to lock and unlock vehicle steering columns, and to lock and unlock interior storage bins, such as glove boxes. Other uses are also envisioned.

Key 20 includes communication and control circuitry 22 and memory 24. Communication and control circuitry 22 receives an encrypted code from computer 12 and stores the encrypted code in memory 24. Communication and control circuitry 22 may also send the encrypted code to computer 12. Transaction software 14 may then request that host computer 30 verify that the code stored in memory 24 is the correct code for vehicle security system 40.

Key 20 may be a wired or wireless device. For example, key 20 may include NFC capability. Key 20 may derive power from code reader/writers 16 and 42 or optionally a battery 26. Key 20 may be a passive device.

Memory 24 may include static or dynamic rewritable memory. A rewritable memory offers the advantage of eliminating a permanent association between a particular key 20 and vehicle security system 40. Any key 20 not involved in a current vehicle rental transaction may be cleared of its encrypted code or reprogrammed with another encrypted code associated with another vehicle security system 40. Following the rental period agreed upon in the rental transaction, which may be construed as the return of vehicle 44 and key 20, key 20 may be stored in a bin with other keys 20 until it is selected for use in a subsequent vehicle rental transaction.

Host computer 30 may be located on or off site from a vehicle rental location. Host computer 30 executes code management software 32 for storing, retrieving, and encrypting unique codes associated with vehicle security systems 40. Computer 12 may be coupled to host computer 30 via wired or wireless network connections, or a combination of the both. The functions of computer 12 and host computer 30 may be combined into one computer.

In one example embodiment, customers obtain keys 20 from vehicle rental locations. During an assisted-service transaction, a customer may obtain a programmed key 20 from an employee. During a self-service transaction, a customer may obtain an available unprogrammed key 20 from an employee or an adjacent bin and program it using self-service transaction terminal 20. During a transaction with a roaming employee, a customer may obtain a programmed key 20 from the roaming employee. Following an on-line transaction, transaction software 14 may issue the customer with credentials for obtaining key 20 upon arrival at the vehicle rental location. The customer may obtain a programmed key 20 using any of the methods identified in this paragraph.

In another example embodiment, some customers, such as loyalty customers, may go straight to their assigned vehicles and find programmed keys 20 there.

In yet another example embodiment, some customers, such as loyalty customers, may retain keys 20. Transaction software 14 reprograms such keys 20 during each vehicle rental transaction.

Vehicle security system 40 controls one or more functions related to the security of a vehicle, which may include controlling electronic ignition, electric door locks, transmission position, and alarms. Vehicle security system 40 obtains an encrypted code from key 20, decrypts the code using an encryption key, which may include a sequence of numbers used to encrypt or decrypt vehicle codes, and compares it a reference code stored within a memory of vehicle computer system 40. If the codes match, vehicle computer system 40 disables alarms, releases door locks, permits starting of the vehicle, and permits placing the transmission in gear. If the codes do not match, then a security violation has occurred. A legitimate customer whose key 20 has a code that does not match must reprogram key 20, have it reprogrammed, or obtain a new key 20.

Vehicle security system 40 uses code reader/writer 42 to communicate with key 20. Code reader/writer 42 may include a wired or wireless device. For example, code reader/writer 42 may include an NFC reader/writer. Code reader/writer 42 may be connected to vehicle security system 40 through a wired connection, such as a universal serial bus (USB) connection. Code reader/writer 42 may alternatively be integrated within vehicle security system 40.

Vehicle security system 40 may also communicate directly with host computer 30. In one example embodiment, vehicle security system 40 may communicate with host computer 30 over a cellular connection to security information within vehicle security system, such as encryption key updates. For this purpose, host computer 30 and vehicle security system 40 would include cellular communication circuitry.

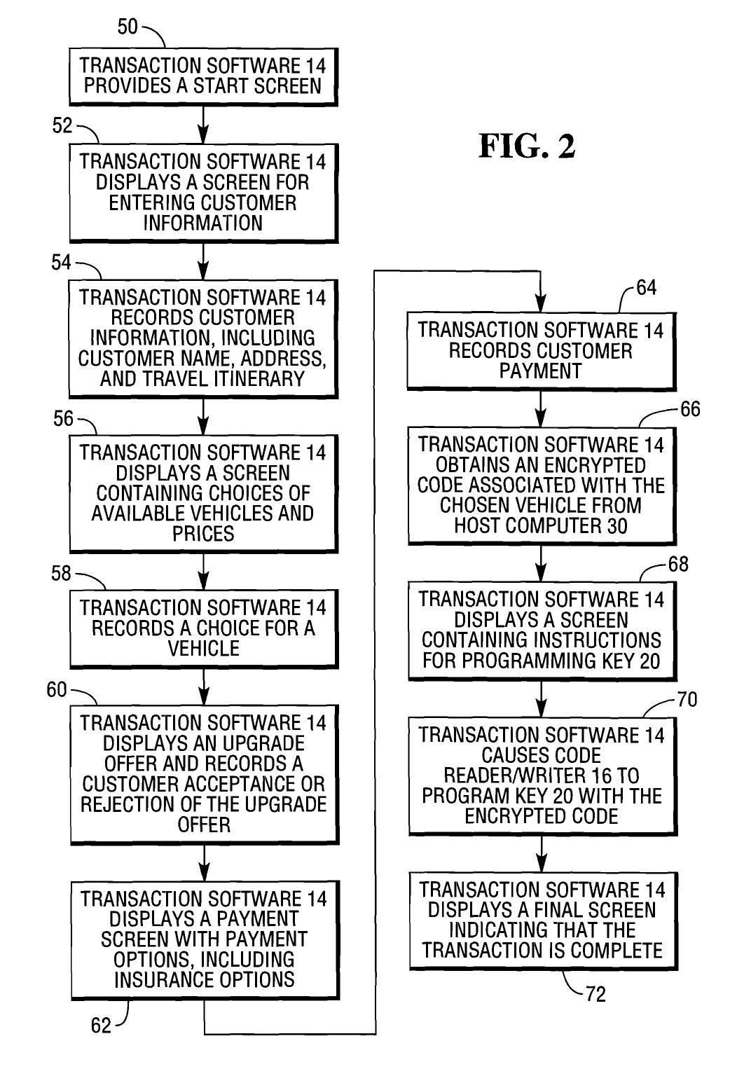

With reference to FIG. 2, an example method of operation is illustrated. This method involves a customer who is located at a vehicle rental facility and completes either an assisted-service or self-service transaction.

In step 50, transaction software 14 provides a start screen. The start screen may include a web page. A customer or employee chooses an option to begin a new transaction.

In step 52, transaction software 14 displays a screen for entering customer information.

In step 54, transaction software 14 records customer information, including customer name, address, and travel itinerary. Customers may provide loyalty or club membership information during this step.

In step 56, transaction software 14 displays a screen containing choices of available vehicles and prices.

In step 58, transaction software 14 records a choice for a vehicle.

In step 60, transaction software 14 optionally displays an upgrade offer and records a customer acceptance or rejection of the upgrade offer.

In step 62, transaction software 14 displays a payment screen with payment options, including insurance options.

In step 64, transaction software 14 records customer payment.

In step 66, transaction software 14 obtains an encrypted code associated with the chosen vehicle from host computer 30.

In step 68, transaction software 14 displays a screen containing instructions for programming key 20.

In step 70, transaction software 14 causes code reader/writer 16 to program key 20 with the encrypted code.

In step 72, transaction software 14 displays a final screen indicating that the transaction is complete.

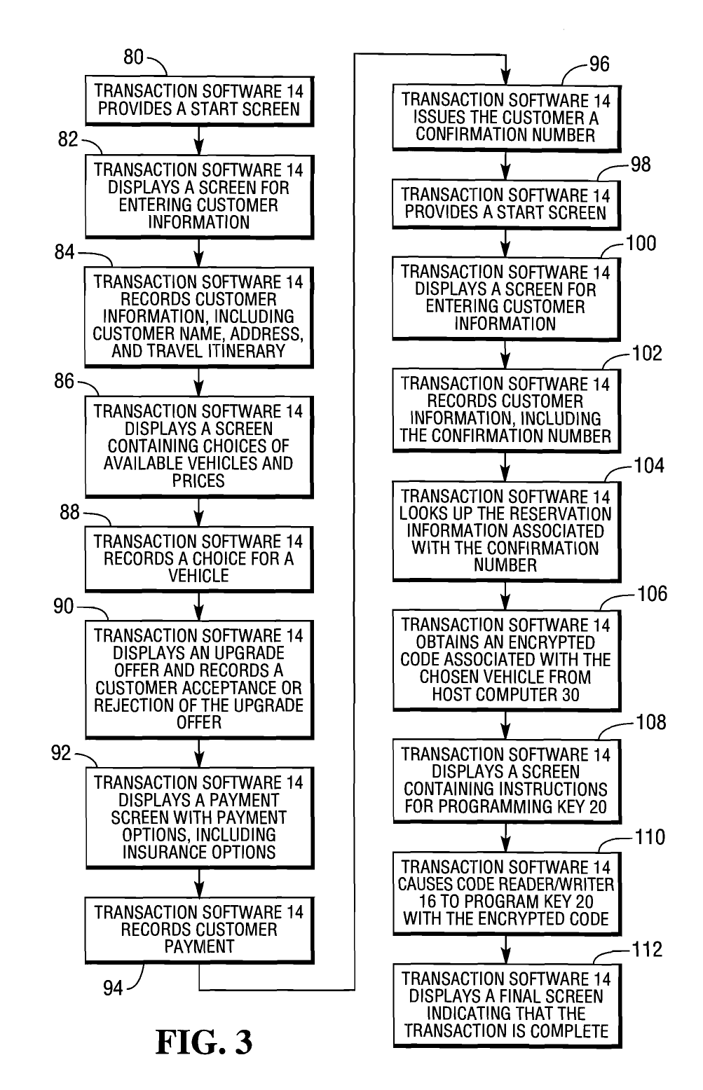

With reference to FIG. 3, another example method of operation is illustrated involving an on-line customer.

In step 80, transaction software 14 displays a start screen. The customer connects to the vehicle rental facility web site and begins a vehicle rental transaction.

In step 82, transaction software 14 displays a screen for entering customer information.

In step 84, transaction software 14 records customer information, including customer name, address, and travel itinerary.

In step 86, transaction software 14 displays a screen containing choices of available vehicles and prices.

In step 88, transaction software 14 records a choice for a vehicle.

In step 90, transaction software 14 optionally displays an upgrade offer and records a customer acceptance or rejection of the upgrade offer.

In step 92, transaction software 14 displays a payment screen with payment options, including insurance options.

In step 94, transaction software 14 records customer payment.

In step 96, transaction software 14 issues the customer a confirmation number or other credentials indicating that the customer has completed a vehicle rental transaction.

The customer completes the remainder of steps during a subsequent visit to a vehicle rental facility using an assisted-service or full-service computer 12.

In step 98, transaction software 14 provides a start screen.

In step 100, transaction software 14 displays a screen for entering customer information.

In step 102, transaction software 14 records customer information, including the confirmation number.

In step 104, transaction software 14 looks up the reservation information associated with the confirmation number.

In step 106, transaction software 14 obtains an encrypted code associated with the chosen vehicle from host computer 30.

In step 108, transaction software 14 displays a screen containing instructions for programming key 20.

In step 110, transaction software 14 causes code reader/writer 16 to program key 20 with the encrypted code.

In step 112, transaction software 14 displays a final screen indicating that the transaction is complete.

Although particular reference has been made to certain embodiments, variations and modifications are also envisioned within the spirit and scope of the following claims.

What is claimed is:

1. A system comprising:
a computer for completing a vehicle rental transaction involving one of a plurality of different vehicles, for determining an encrypted code associated with a vehicle security system of the one vehicle, and for storing the encrypted code in a reusable programmable key to limit use of the key to operating the one vehicle during a rental period defined by the vehicle rental transaction.

2. The system of claim 1, wherein the computer is also for completing another vehicle rental transaction after the one rental period and involving another one of the plurality of different vehicles, for determining another encrypted code associated with another vehicle security system of the other vehicle, and for storing the other encrypted code in the reusable programmable key to limit use of the key to operating the other vehicle during another rental period defined by the other vehicle rental transaction.

3. The system of claim 1, wherein the computer obtains the encrypted code from a host computer.

4. The system of claim 1, further comprising a code reader/writer coupled to the computer for storing the encrypted code in the key.

5. The system of claim 1, wherein the computer comprises an online computer for completing the vehicle rental transaction over the Internet.

6. The system of claim 1, wherein the computer comprises a self-service computer for completing the vehicle rental transaction at a vehicle rental location.

7. The system of claim 1, wherein the computer comprises an assisted-service computer for completing the vehicle rental transaction at a vehicle rental location.

8. The system of claim 1, wherein the computer comprises a portable computer for completing the vehicle rental transaction at a vehicle rental location.

9. A vehicle key comprising:
a rewritable memory; and
wireless communication and control circuitry for receiving and storing an encrypted code associated with any one of a plurality of different rental vehicles in the memory as part of a rental transaction, and for sending the encrypted code to a vehicle security system within the one rental vehicle to operate only the one rental vehicle during a rental period defined in the rental transaction;
wherein the key is reprogrammable for use in another of the different rental vehicles as part of another rental transaction after the rental period.

10. The system of claim 9, wherein the wireless communication and control circuitry is also for sending an encrypted code stored in the memory to the computer for verifying that the encrypted code stored in the memory is the encrypted code associated with the vehicle security system of the one vehicle.

11. The system of claim 9, wherein the wireless communication circuitry is capable of standard near field communications.

12. The system of claim 9, wherein the memory comprises a rewritable memory.

13. A system comprising:
a rental vehicle including a vehicle security system; and
a key for operating the rental vehicle including
a rewritable memory; and
wireless communication and control circuitry for receiving and storing an encrypted code associated with the rental vehicle in the memory as part of a rental transaction, and for sending the encrypted code to the vehicle security system within the rental vehicle to operate only the rental vehicle during a rental period defined in the rental transaction;
wherein the key is reprogrammable for use in another rental vehicle as part of another rental transaction after the rental period.

14. A vehicle rental transaction method comprising:
recording customer information by a transaction computer;
recording a choice of one vehicle out of a plurality of different vehicles by the transaction computer;
recording payment for rental of the one vehicle for a rental period by the transaction computer;
obtaining an encrypted code associated with the one vehicle; and
programming a reusable key with the encrypted code to limit use of the key to operating the one vehicle during the rental period.

15. The method of claim 14, wherein the transaction computer comprises a self-service computer for completing a rental transaction at a rental location.

16. The method of claim 14, wherein the transaction computer comprises an assisted-service computer for completing a rental transaction at a rental location.

17. The method of claim 14, wherein the transaction computer comprises a portable computer for completing a rental transaction at a rental location.

18. The method of claim 14, wherein the transaction computer comprises an online computer for completing a rental transaction over the Internet.

19. The method of claim 18, further comprising issuing a confirmation to an online customer for presentation at a vehicle rental location.
